(19) United States
(12) Patent Application Publication
(10) Pub. No.: US 2025/0218374 A1
(43) Pub. Date: Jul. 3, 2025

(54) Pixel Circuit and Display Device Including the Same

(71) Applicant: LG Display Co., Ltd., Seoul (KR)

(72) Inventors: Woo Kyu Sang, Paju-si (KR); Hyoung Sik Kim, Paju-si (KR)

(21) Appl. No.: 18/962,827

(22) Filed: Nov. 27, 2024

(30) Foreign Application Priority Data
Dec. 29, 2023 (KR) 10-2023-0196275

(51) Int. Cl. G09G 3/3233; G09G 3/32; G09G 3/3291

(52) U.S. Cl. CPC G09G 3/3233; G09G 3/32; G09G 3/3291; G09G 2300/0819; G09G 2300/0852; G09G 2310/08; G09G 2320/045

(57) ABSTRACT

Embodiments disclose a pixel circuit including a driving element including a gate electrode connected to a first node, a first electrode connected to a second node, and a second electrode connected to a third node, a light-emitting element connected to the second electrode of the driving element, a first capacitor connected to the first node and a fourth node, a second capacitor connected to the fourth node and the second node, a first switch element connected to the first node and the third node, a second switch element connected to the fourth node and a reference voltage supply line, and a third switch element connected to the first node and an initialization voltage supply line, and a display device including the same.

### CROSS-REFERENCE TO RELATED APPLICATION

This application claims priority to and the benefit of Republic of Korea Patent Application No. 10-2023-0196275, filed on Dec. 29, 2023, which is hereby incorporated by reference in its entirety.

### 1. TECHNICAL FIELD

Embodiments relate to a pixel circuit and a display device including the same.

### 2. DISCUSSION OF RELATED ART

In the information society, various technologies have been developed in the field of display devices for displaying visual information in the form of an image or video. Among various display devices, an organic light-emitting display device is being highlighted as a next-generation display in that the organic light-emitting display device uses an organic light-emitting diode, which is a self-luminous element that emits light from a light emission layer thereof through re-combination of an electron and a hole, and thus has a fast response time, high luminance, and a low driving voltage, can be made ultra-thin, and can be implemented to have various shapes.

The organic light-emitting display device usually reduces luminance unevenness by compensating the characteristics of a driving transistor (thin-film transistor) configured to control a driving current flowing to the organic light-emitting diode.

### SUMMARY

However, it is newly recognized by the inventors of the present disclosure that: in the trend of high-resolution and high-speed driving of the organic light-emitting display device, a conventional compensation method cannot sufficiently compensate for differences in the driving characteristics of pixels. For example, as a resolution and/or a driving frequency increases, one horizontal period H during which data is written to pixels in one line in a display panel is reduced. One horizontal period H is a time for writing data to the pixels disposed in one horizontal line on a screen.

A driving circuit of the organic light-emitting display device samples a threshold voltage (Vth) of a driving transistor within one horizontal period (H), compensates a data voltage by the threshold voltage (Vth), and writes data to the pixels. Thus, when the one horizontal period (H) is reduced, a time required to sample the threshold voltage (Vth) of the driving transistor is reduced.

When the time required to sample the threshold voltage (Vth) of the driving transistor is insufficient, the threshold voltage (Vth) of the driving transistor may be sensed inaccurately, resulting in differences in driving characteristics between the pixels.

An embodiment of the present disclosure is to provide a pixel circuit and a display device including the same that substantially obviate one or more of the issues due to limitations and disadvantages of the related art.

Another embodiment of the present disclosure is to provide a pixel circuit capable of securing sufficient sampling time even during high-speed driving, and a display device including the same.

Another embodiment of the present disclosure is to also provide a display device capable of preventing or reducing a short-circuit between a pixel driving voltage and an initialization voltage in an initialization period.

It should be noted that embodiment of the present disclosure are not limited to the above-described aspects, and other aspects of the present disclosure will be apparent to those skilled in the art from the following descriptions.

According to an embodiment of the present disclosure, there is provided a pixel circuit including a driving element including a gate electrode connected to a first node, a first electrode connected to a second node, and a second electrode connected to a third node, a light-emitting element connected to the second electrode of the driving element, a first capacitor connected to the first node and a fourth node, a second capacitor connected to the fourth node and the second node, a first switch element connected to the first node and the third node, a second switch element connected to the fourth node and a reference voltage supply line, and a third switch element connected to the first node and an initialization voltage supply line.

A reference voltage applied from the reference voltage supply line may be greater than an initialization voltage applied from the initialization voltage supply line.

The first capacitor may be initialized by applying the reference voltage and the initialization voltage to both ends of the first capacitor respectively.

The second capacitor may be initialized by applying the reference voltage and a pixel driving voltage to both ends of the second capacitor respectively.

The pixel circuit may include a fifth switch element configured to connect the initialization voltage supply line and an anode of the light-emitting element, and a first gate line connected to gate electrodes of the third switch element and the fifth switch element.

The pixel circuit may include a fourth switch element connected to the fourth node and a data voltage supply line.

The pixel circuit may include a first gate line that applies a first gate voltage to a gate electrode of the third switch element, a second gate line that applies a second gate voltage to a gate electrode of the second switch element, a third gate line that applies a third gate voltage to a gate electrode of the first switch element, and a fourth gate line that applies a fourth gate voltage to a gate electrode of the fourth switch element.

The pixel circuit may be driven in an initialization period, a sampling period, a programming period, and an emission period, during the initialization period, the second switch element, the third switch element and the driving element are turned on, and the first switch element and the fourth switch element are turned off; during the sampling period, the first switch element and the second switch element are turned on such that a level of the fourth node is fixed at the reference voltage, and the level of the first node is changed from the initialization voltage to a difference between a pixel driving voltage and a threshold voltage of the driving element; during the programming period, the fourth switch element is turned on, and the first to third switch elements are turned off, such that the level of the first node is changed to the difference between the pixel driving voltage and the threshold voltage of the driving element, and during the emission period, a current flowing through the driving element has no relevance to the pixel driving voltage or the threshold voltage of the driving element.

The reference voltage may be greater than a data voltage applied from the data voltage supply line.

The initialization voltage supply line may be electrically isolated from the second electrode of the driving element.

According to another embodiment of the present disclosure, there is provided a display device including a data driving circuit, a gate driving circuit, and a pixel circuit including a driving element including a gate electrode connected to a first node, a first electrode connected to a second node, and a second electrode connected to a third node, a light-emitting element connected to the second electrode of the driving element, a first capacitor disposed between the first node and a fourth node, a second capacitor disposed between the fourth node and the second node, a first switch element disposed between the first node and the third node, a second switch element disposed between the fourth node and a reference voltage supply line, and a third switch element disposed between the first node and an initialization voltage supply line.

The pixel circuit may be driven in an initialization period, a sampling period, a programming period, and an emission period, in the initialization period, a reference voltage and an initialization voltage are applied to the capacitor, in the sampling period, a threshold voltage of the driving element is sampled using the reference voltage and a pixel driving voltage, and in the programming period, a data voltage is applied to the pixel circuit to store the data voltage in the capacitor.

According to the present disclosure, a sampling time longer than one horizontal period can be secured, so that accurate sampling is possible even during high-speed driving. Accordingly, there is an advantage of achieving uniform driving characteristics between pixels even during high-speed driving.

According to the present disclosure, by ensuring that a pixel driving voltage and an initialization voltage are not short-circuited during initialization, damage to a pixel circuit can be minimized or reduced and low power control can be achieved.

It is to be understood that both the foregoing general description and the following detailed description are exemplary and explanatory and are intended to provide further explanation of the inventive concepts as claimed.

### BRIEF DESCRIPTION OF THE DRAWINGS

The accompanying drawings, that may be included to provide a further understanding of the disclosure and may be incorporated in and constitute a part of the disclosure, illustrate embodiments of the disclosure and together with the description serve to explain various principles of the disclosure.

The above and other aspects, features, and effects of the present disclosure will become more apparent to those of ordinary skill in the art by describing exemplary embodiments thereof in detail with reference to the accompanying drawings, in which:

FIG. 1 is a block diagram illustrating a display device according to an embodiment of the present disclosure;

FIG. 2 is a cross-sectional view of the display panel illustrated in FIG. 1 according to an embodiment of the present disclosure;

FIG. 3 is a diagram schematically illustrating the display device according to an embodiment of the present disclosure;

FIG. 4 is a circuit diagram illustrating a pixel circuit according to an embodiment of the present disclosure;

FIG. 5A is a circuit diagram illustrating an example operation of the pixel circuit in an initialization period according to an embodiment of the present disclosure;

FIG. 5B is an example of a waveform diagram illustrating the operation of the pixel circuit in the initialization period according to an embodiment of the present disclosure;

FIG. 6A is a circuit diagram illustrating an example operation of the pixel circuit in a sampling period according to an embodiment of the present disclosure;

FIG. 6B is an example of a waveform diagram illustrating the operation of the pixel circuit in the sampling period according to an embodiment of the present disclosure;

FIG. 7 is an example of a waveform diagram illustrating a state in which the sampling period is controlled to be longer than one horizontal period according to an embodiment of the present disclosure;

FIG. 8A is a circuit diagram illustrating an example operation of the pixel circuit in a programming period according to an embodiment of the present disclosure;

FIG. 8B is an example of a waveform diagram illustrating the operation of the pixel circuit in the programming period according to an embodiment of the present disclosure;

FIG. 9A is a circuit diagram illustrating an example operation of the pixel circuit in an emission period according to an embodiment of the present disclosure;

FIG. 9B is an example of a waveform diagram illustrating the operation of the pixel circuit in the emission period according to an embodiment of the present disclosure;

FIG. 10 is a diagram schematically illustrating the pixel circuit according to an embodiment of the present disclosure;

FIG. 11 is a diagram illustrating an example of a pixel circuit that performs sampling using a data voltage according to an embodiment of the present disclosure;

FIG. 12 is a waveform diagram of the circuit of FIG. 11 according to an embodiment of the present disclosure;

FIG. 13 is a circuit diagram illustrating a pixel circuit according to another embodiment of the present disclosure; and

FIG. 14 is a waveform diagram of the pixel circuit according to another embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or briefly provided. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Advantages and features of the present disclosure and implementation methods thereof will be clarified through the following example embodiments described with reference to the accompanying drawings. The present disclosure is not limited to the following example embodiments but may be implemented in various different forms. The example embodiments are provided only to complete the present disclosure and to fully provide a person having ordinary skill in the art to which the present disclosure pertains with the category of the present disclosure, and the present disclosure will be defined by the appended claims.

The figures, dimensions, ratios, angles, numbers, and the like disclosed in the drawings for describing the example embodiments of the present disclosure are merely illustrative and thus the present disclosure is not limited to matters illustrated in the drawings. Throughout the specification, like reference numerals refer to substantially like components. Further, in describing the present disclosure, detailed descriptions of well-known technologies will be omitted when it is determined that they may unnecessarily obscure the gist of the present disclosure. Any implementation described herein as an “example” is not necessarily to be construed as preferred or advantageous over other implementations.

Terms such as “including,” “having,” and “composed of” used herein are intended to allow other elements to be added unless the terms are used with the term “only.” When a component is expressed in the singular form, it may be construed as the plural form unless otherwise explicitly stated.

Components are interpreted to include an ordinary error range even if not expressly stated.

When the positional or interconnected relationship between two components is described using the terms such as “on,” “over,” “under,” “above,” “below,” “beneath,” “near,” “close to,” or “adjacent to,” “beside,” “next to,” “connect or couple,” “crossing or intersecting,” and the like, one or more other components may be interposed between the two components unless a more limiting term, such as “immediately”, “closely” or “directly” is used. Furthermore, the terms “left,” “right,” “top,” “bottom, “downward,” “upward,” “upper,” “lower,” and the like refer to an arbitrary frame of reference.

When the temporal order relationship is described using the terms such as “after,” “subsequent to,” “next,” “before,” and the like, a case that is not continuous may be included unless a more limiting term, such as “just”, “immediately” or “directly” is used.

Although ordinal numbers such as first, second, “A,” “B,” “(a),” and “(b),” and the like are used to distinguish between components, the functions or structures of these components are not limited by the ordinal numbers before the component or the name of the component. Also, when an element or layer is described as being “connected,” “coupled,” or “adhered” to another element or layer, the element or layer can not only be directly connected, or adhered that other element or layer, but also be indirectly connected, or adhered that other another element or layer with one or more intervening elements or layers disposed between the elements or layers, unless otherwise specified.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

The following embodiments may be partially or entirely coupled to or combined with each other and may be interoperated and performed in technically various ways. Each of the embodiments may be independently operable with respect to each other and may be implemented together in related relationships.

Unless otherwise defined, all terms (including technical and scientific terms) used in embodiments of the present specification may be interpreted as meanings that may be generally understood by those skilled in the art to which the present specification pertains unless explicitly specifically defined and described, and the meanings of the commonly used terms, such as terms defined in a dictionary, may be interpreted in consideration of contextual meanings of the related technology and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

In a display device of the present disclosure, a pixel circuit and a gate driving circuit may include a plurality of transistors. The transistors may be oxide thin-film transistors (TFTs) including an oxide semiconductor, or low-temperature polysilicon (LTPS) TFTs including LTPS.

The transistors are three-electrode elements including a gate, a source, and a drain. The source is an electrode that provides carriers to the transistor. The carriers in the transistor start to flow from the source. The drain is an electrode through which the carriers are discharged from the transistor to the outside. In the transistor, the carriers flow from the source to the drain. In the case of an n-channel transistor, carriers are electrons, and thus a source voltage is lower than a drain voltage so that the electrons flow from the source to the drain. In the n-channel transistor, current flows from the drain to the source. In the case of a p-channel transistor, carriers are holes, and thus a source voltage is higher than a drain voltage so that the holes flow from the source to the drain. In the p-channel transistor, since the holes flow from the source to the drain, current flows from the source to the drain. It should be noted that the source and the drain of the transistor are not fixed in position. For example, the source and the drain are interchangeable depending on the applied voltage. Accordingly, the present disclosure is not limited by the source and the drain of the transistor. In the following description, the source and the drain of the transistor will be referred to as a first electrode and a second electrode.

A gate signal may swing between a gate-on voltage and a gate-off voltage. The transistor is turned on in response to the gate-on voltage and turned off in response to the gate-off voltage. In the case of an n-channel transistor, the gate-on voltage may be a gate-high voltage VGH, and the gate-off voltage may be a gate-low voltage VGL. In the case of a p-channel transistor, the gate-on voltage may be the gate-low voltage VGL, and the gate-off voltage may be the gate-high voltage VGH.

Hereinafter, various example embodiments of the present disclosure will be described in detail with reference to the accompanying drawings.

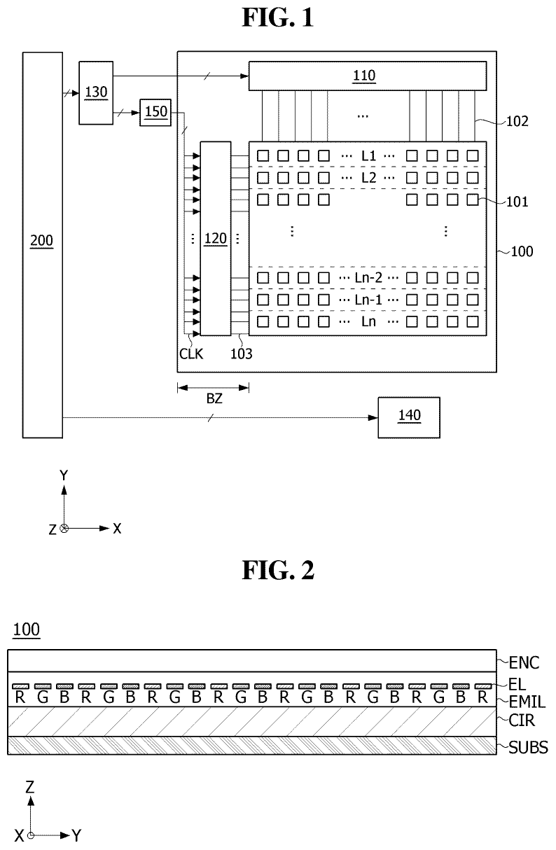

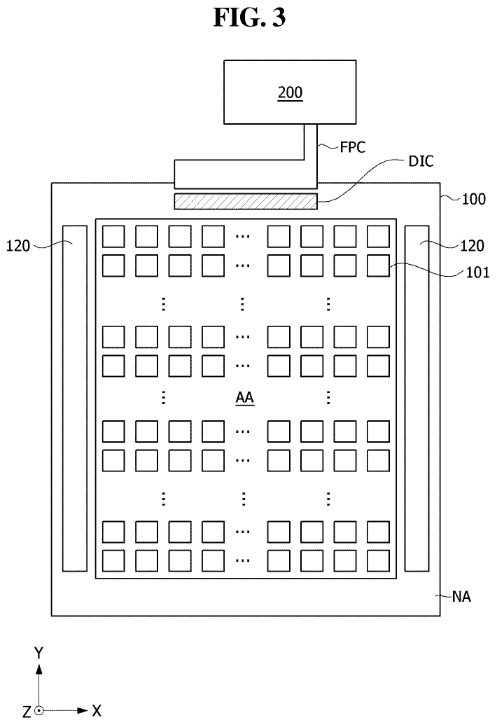

FIG. 1 is a block diagram illustrating a display device according to an embodiment of the present disclosure. FIG. 2 is a cross-sectional view of the display panel illustrated in FIG. 1 according to an embodiment of the present disclosure. FIG. 3 is a diagram schematically illustrating the display device according to an embodiment of the present disclosure.

Referring to FIGS. 1 to 3, the display device according to the embodiment of the present disclosure includes a display panel 100, a display panel driving circuit configured to write pixel data to pixels of the display panel 100, and a power supply 140 configured to generate power required for driving the pixels and the display panel driving circuit.

The display panel 100 may be made of a plastic substrate, a thin glass substrate, or a metal substrate. Pixels 101 are implemented on the display panel 100.

The display panel 100 may be a panel having a rectangular structure with a length in an X-axis direction, a width in a Y-axis direction, and a thickness in a Z-axis direction, but the present disclosure is not limited thereto. A display area AA of the display panel 100 includes a pixel array configured to display an input image. The pixel array includes a plurality of data lines 102, a plurality of gate lines 103 intersecting the data lines 102, and the pixels 101 disposed in a matrix form. The display panel 100 may further include power lines commonly connected to the pixels 101. The power lines are connected to constant voltage nodes of the pixel circuits and supply a constant voltage necessary for driving the pixels 101 to the pixels 101.

Each of the pixels 101 may be divided into a red sub-pixel, a green sub-pixel, and a blue sub-pixel for color implementation. Each of the pixels may further include a white sub-pixel. Each of the sub-pixels includes a pixel circuit for driving a light-emitting element. Each of the pixel circuits is connected to the data line, the gate line, and the power line. Hereinafter, a “pixel” may be interpreted as a “sub-pixel.”

The pixels may be disposed as real color pixels or pentile pixels. In the pentile pixel, two sub-pixels of different colors are driven as one pixel 101 using a predetermined pixel rendering algorithm to realize a resolution higher than a resolution of the real-color pixel. The pixel rendering algorithm may compensate for insufficient color representation of each pixel using colors of light emitted from adjacent pixels.

The pixel array includes a plurality of pixel lines L1 to Ln. Each of the pixel lines L1 to Ln includes one line of pixels disposed in a line direction (X-axis direction) in the pixel array of the display panel 100. The pixels disposed in one pixel line share the gate lines 103. The sub-pixels disposed in a column direction (Y-axis direction) along the data line share the same data line 102. One horizontal period is a time obtained by dividing one frame period by the total number of the pixel lines L1 to Ln.

The display panel 100 may be implemented as a non-transmissive display panel or a transmissive display panel. The transmissive display panel is applicable to a transparent display device in which an image is displayed on a screen and a real background object is visible. The display panel 100 may be manufactured as a flexible display panel.

The cross-sectional structure of the display panel 100 may include a circuit layer CIR, a light-emitting element layer EMIL, and an encapsulation layer ENC stacked on a substrate SUBS, as shown in FIG. 2.

The circuit layer CIR may include a thin-film transistor (TFT) array including a pixel circuit connected to lines such as the data line, the gate line, the power line, and the like, a demultiplexer array, a gate driver 120, and the like. The circuit layer CIR includes a plurality of metal layers insulated with insulating layers interposed therebetween, and a semiconductor material layer.

The light-emitting element layer EMIL may include light-emitting elements EL driven by the pixel circuit. The light-emitting elements may include a light-emitting element of a red sub-pixel, a light-emitting element of a green sub-pixel, and a light-emitting element of a blue sub-pixel. The light-emitting element layer EMIL may further include a light-emitting element of a white sub-pixel. The light-emitting element layer EMIL in each of the sub-pixels may have a structure in which the light-emitting element and a color filter are stacked. The light-emitting elements EL of the light-emitting element layer EMIL may be covered by a multi-layered protective layer including an organic film and an inorganic film.

The encapsulation layer ENC covers the light-emitting element layer EMIL to seal the circuit layer CIR and the light-emitting element layer EMIL. The encapsulation layer ENC may have a multi-insulating film structure in which an organic film and an inorganic film are alternately stacked. The inorganic film blocks the penetration of moisture or oxygen. The organic film planarizes a surface of the inorganic film. When the organic film and the inorganic film are stacked in multiple layers, a moving path of moisture or oxygen becomes longer compared to that of a single layer, and thus, the penetration of moisture and oxygen affecting the light-emitting element layer EMIL may be effectively blocked.

A touch sensor layer omitted from the drawing may be formed on the encapsulation layer ENC and a polarizing plate or a color filter layer may be disposed on the touch sensor layer. The touch sensor layer may include capacitive touch sensors that sense a touch input based on a change in capacitance before and after the touch input. The touch sensor layer may include metal wiring patterns that form the capacitance of the touch sensors and insulating films. The insulating films may insulate intersections of the metal wiring patterns and planarize a surface of the touch sensor layer. The polarizing plate may improve visibility and a contrast ratio by converting the polarization of external light reflected from the metals of the touch sensor layer and the circuit layer. The polarizing plate may be implemented as a polarizing plate in which a linear polarizing plate and a phase retardation film are bonded, or a circular polarizing plate. Cover glass may be adhered on the polarizing plate. The color filter layer may include red, green, and blue color filters. The color filter layer may further include a black matrix pattern. The color filter layer may absorb a part of a wavelength of light reflected from the circuit layer and the touch sensor layer to replace the role of the polarizing plate, and may increase the color purity of an image reproduced on the pixel array.

The power supply 140 generates constant voltages (or direct current (DC) voltages) necessary to drive the display panel driving circuit and the pixel array of the display panel 100 by using a DC-DC converter. The DC-DC converter may include a charge pump, a regulator, a buck converter, a boost converter, and the like. The power supply 140 may adjust the level of a DC input voltage applied from a host system 200 to generate constant voltages such as a gamma reference voltage, a gate-high voltage, a gate-low voltage, a pixel driving voltage, a cathode voltage, an initialization voltage, and the like. The gamma reference voltage is supplied to a data driver 110. A dynamic range of a data voltage output from the data driver 110 is determined by a voltage range of the gamma reference voltage. The dynamic range of the data voltage is a voltage range between the highest grayscale voltage and the lowest grayscale voltage.

The gate-high voltage and the gate-low voltage are supplied to a level shifter 150 and the gate driver 120. The constant voltages such as the pixel driving voltage, the cathode voltage, and the initialization voltage are supplied to the pixels 101 via the power lines commonly connected to the pixels 101.

The pixel driving voltage may be output from a main power source of the host system 200 and supplied to the display panel 100. In this case, the pixel driving voltage does not need to be output from the power supply 140.

The display panel driving circuit writes pixel data of an input image to the pixels of the display panel 100 under control of a timing controller 130. The display panel driving circuit includes the data driver 110 and the gate driver 120.

The display panel driving circuit may further include a touch sensor driver for driving the touch sensors. The touch sensor driver is omitted from FIG. 1. The data driver 110 and the touch sensor driver may be integrated into one driver integrated circuit (IC). In a mobile terminal or a wearable terminal, the timing controller 130, the power supply 140, the level shifter 150, the data driver 110, the touch sensor driver, and the like may be integrated into one driver IC DIC as shown in FIG. 3.

The data driver 110 receives pixel data of an input image received as a digital signal from the timing controller 130 and outputs a data voltage. The data driver 110 outputs the data voltage by converting the pixel data of the input image into a gamma compensation voltage, using a digital-to-analog converter (DAC). A gamma reference voltage VGMA is supplied to the DAC by being divided into a gamma compensation voltage for each grayscale through a voltage divider circuit of the data driver 110. The DAC generates the data voltage using a gamma compensation voltage corresponding to a grayscale value of the pixel data. The data voltage output from the DAC may be output to the data line 102 through an output buffer in each of channels of the data driver 110 or may be output to the data line 102 via the demultiplexer array.

The gate driver 120 may be formed in the circuit layer CIR on the display panel 100 together with the TFT array of the pixel array and the lines. The gate driver 120 may be disposed in non-display areas BZ outside the display area AA of the display panel 100 or at least partially disposed in the display area AA.

The gate driver 120 may include a plurality of shift registers for sequentially shifting pulses of gate signals. The gate driver 120 is disposed on either a left non-display area BZ or a right non-display area BZ outside the display area AA in the display panel 100 to supply the gate signals to the gate lines 103 by a single feeding method. In the single feeding method, the gate signal is applied from one side end of the gate line 103. The gate driver 120 may be disposed in each of the left and right non-display areas BZ of the display panel 100 and may apply the gate signals to the gate lines 103 by a double feeding method. In the double feeding method, the gate signals are applied simultaneously from both side ends of the gate line 103. At least some circuits of the gate driver 120 may be disposed in the display area AA.

The gate driver 120 sequentially outputs pulses of the gate signals to the gate lines under control of the timing controller 130. The gate driver 120 may sequentially supply the gate signals to the gate lines 103 by shifting pulses of the gate signals using the shift registers. The gate driver 120 may output a plurality of gate signals with different phases and pulse widths using the plurality of shift registers. The gate signals may be divided into scan signals and light emission control signals (hereinafter referred to as “EM signals”).

The timing controller 130 receives digital video data of an input image and timing signals synchronized with the digital video data from the host system 200. The timing signals may include a vertical synchronization signal Vsync, a horizontal synchronization signal Hsync, a data enable signal DE, and the like. The vertical synchronization signal Vsync and the horizontal synchronization signal Hsync may be omitted since a vertical period and a horizontal period may be obtained by a method of counting the data enable signal DE. The data enable signal DE has a period of one horizontal period 1H.

The timing controller 130 may generate a data timing control signal for controlling an operation timing of the data driver 110, a switch control signal for controlling an operation timing of the demultiplexer array, and a multiplexer (MUX) control signal for controlling an operation timing of the gate driver 120 based on the timing signals Vsync, Hsync, and DE received from the host system 200. The timing controller 130 controls the operation timing of the display panel driving circuit to synchronize the data driver 110, the demultiplexer array, the touch sensor driver, and the gate driver 120 therewith.

The gate timing control signal generated by the timing controller 130 may be input to the shift register of the gate driver 120 through the level shifter 150. The level shifter 150 may receive the gate timing control signal and generate and provide a start pulse and a shift clock to the gate driver 120 through clock lines CLK. The level shifter 150 may supply the MUX control signal to the demultiplexer array. The input signal of the level shifter 150 may be a digital voltage level signal, and the output signal of the level shifter 150 may be an analog voltage signal swinging between the gate-high voltage VGH and the gate-low voltage VGL.

The host system 200 may include a main board of any one of a television (TV) system, a set-top box, a navigation system, a personal computer (PC), a vehicle system, a mobile terminal, and a wearable terminal. The host system may scale an image signal from a video source to match a resolution of the display panel 100 and transmit a resultant image signal and a timing signal to the timing controller 130.

In the mobile system, the host system 200 may be implemented as an application processor (AP). The host system 200 may transmit the pixel data of the input image to the driver IC DIC through a mobile industry processor interface (MIPI). As shown in FIG. 3, the host system 200 may be connected to the driver IC DIC through a flexible printed circuit, for example, a flexible printed circuit (FPC). The driver IC may be attached on the display panel 100 in a COG (Chip on Glass) process. The driver IC may be mounted on the flexible circuit film and electrically connected to lines on the display panel 100.

Each of the sub-pixels includes a pixel circuit including a driving element for driving the light-emitting element and a capacitor connected to the driving element. The pixel circuit of each of the sub-pixels may include an internal compensation circuit to compensate for the data voltage by a threshold voltage of the driving element.

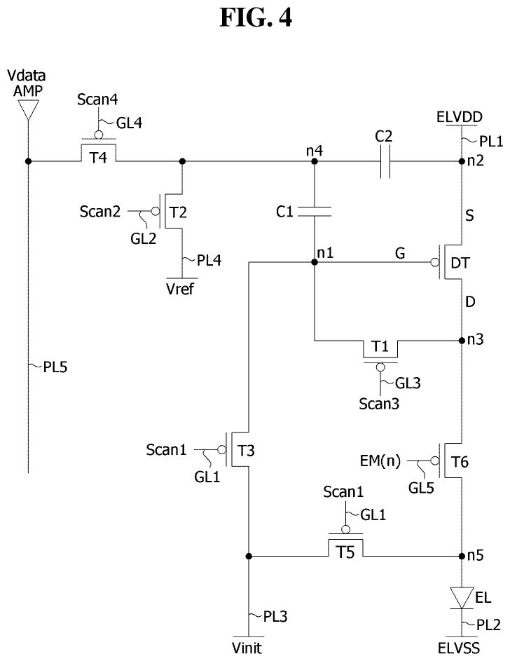

FIG. 4 is a circuit diagram illustrating a pixel circuit according to an embodiment of the present disclosure.

Referring to FIG. 4, the pixel circuit according to the embodiment includes a light-emitting element EL, a driving element DT configured to drive the light-emitting element EL, a plurality of switch elements T1 to T6, and capacitors C1 and C2. The driving element DT and the switch elements T1 to T6 may be implemented as transistors. The driving element DT and the switch elements T1 to T6 may all be p-channel transistors, but the present disclosure is not necessarily limited thereto.

The driving element DT generates a current for driving the light-emitting element EL according to a gate-source voltage Vgs. The driving element DT includes a gate electrode G connected to a first node n1, a first electrode S connected to a second node n2, and a second electrode D connected to a third node n3. A pixel driving voltage ELVDD is applied to the second node n2, and may also be referred to as high-potential power voltage.

The light-emitting element EL may be implemented as an organic light-emitting diode (OLED) or an inorganic LED. The OLED includes an anode, a cathode, and an organic compound layer interposed therebetween. In the light-emitting element EL, the anode is electrically connected to a fifth node n5, and a cathode voltage ELVSS is applied to the cathode and may also be referred to as low-potential power voltage or ground voltage.

The organic compound layer may include a hole injection layer HIL, a hole transport layer HTL, a light emission layer EML, an electron transport layer ETL, and an electron injection layer EIL, but the present disclosure is not limited thereto. When a voltage is applied to the anode and the cathode of the light-emitting element EL, holes passing through the hole transport layer HTL and electrons passing through the electron transport layer ETL move to the light emission layer EML to create excitons. At this time, visible light is emitted from the light emission layer EML. The OLED may be implemented as an OLED with a tandem structure in which a plurality of light emission layers are stacked. The OLED of the tandem structure may improve the luminance and lifespan of the pixel.

A first switch element T1 may have a first electrode connected to the first node n1 and a second electrode connected to the third node n3. A gate electrode of the first switch element T1 may be connected to a third gate line GL3 through which a third scan signal Scan3 is applied. One side of the first switch element T1 (for example, the first electrode) may be connected to the gate electrode of the driving element DT, and the other side of the first switch element T1 (for example, the second electrode) may be connected to the second electrode of the driving element DT and a sixth switch element T6.

The first switch element T1 may be turned on or turned off in response to the third scan signal Scan3, which is applied through the third gate line GL3, and may connect the first node n1 to the third node n3 when turned on.

A second switch element T2 may have a first electrode connected to a fourth node n4 and a second electrode connected to a reference voltage supply line PL4. A gate electrode of the second switch element T2 is connected to a second gate line GL2 through which a second scan signal Scan2 is provided.

The second switch element T2 may be turned on or turned off in response to the second scan signal Scan2, which is supplied through the second gate line GL2, and may supply a reference voltage Vref to the fourth node n4 when turned on.

A third switch element T3 may have a first electrode connected to the first node n1 and a second electrode connected to an initialization voltage supply line PL3. A gate electrode of the third switch element T3 is connected to a first gate line GL1 through which a first scan signal Scan1 is provided.

The third switch element T3 may be turned on or turned off in response to the first scan signal Scan1, which is supplied through the first gate line GL1, and may supply an initialization voltage Vinit to the first node n1 when turned on.

A fourth switch element T4 may have a first electrode connected to a data voltage supply line PL5 and a second electrode connected to the fourth node n4. A gate electrode of the fourth switch element T4 is connected to a fourth gate line GLA through which a fourth scan signal Scan4 is provided.

The fourth switch element T4 may be turned on or turned off in response to the fourth scan signal Scan4, which is supplied through the fourth gate line GL4, and may supply a data voltage Vdata to the fourth node n4 when turned on.

A fifth switch element T5 may have a first electrode connected to the initialization voltage supply line PL3 and a second electrode connected to the fifth node n5. A gate electrode of the fifth switch element T5 is connected to the first gate line GL1 through which the first scan signal Scan1 is provided.

The fifth switch element T5 may be turned on or turned off in response to the first scan signal Scan1, which is supplied through the first gate line GL1, and may supply the initialization voltage Vinit to the anode of the light-emitting element EL when turned on.

The sixth switch element T6 may have a first electrode connected to the third node n3 and a second electrode connected to the fifth node n5. A gate electrode of the sixth switch element T6 is connected to a fifth gate line GL5. The sixth switch element T6 may be turned on or turned off in response to a signal EM(n), which is applied through the fifth gate line GL5, and may connect the third node n3 to the fifth node n5 when turned on.

A first capacitor C1 and a second capacitor C2 may maintain the gate-source voltage Vgs of the driving element DT constant for one frame. The first capacitor C1 may store a threshold voltage Vth of the driving element DT, and the second capacitor C2 may store the data voltage Vdata.

A first terminal of the first capacitor C1 may be connected to the first node n1, and a second terminal thereof may be connected to the fourth node n4. The first terminal of the first capacitor C1 may be connected to the gate electrode of the driving element DT, the first electrode of the first switch element T1, and the first electrode of the third switch element T3.

A first terminal of the second capacitor C2 may be connected to the fourth node n4, and a second terminal thereof may be connected to the second node n2. The fourth node n4 may be disposed between the first capacitor C1 and the second capacitor C2 and connected to the second switch element T2 and the fourth switch element T4. The other side of the second capacitor C2 (for example, the second terminal thereof) may be connected to a driving voltage supply line PL1.

The first capacitor C1 and the second capacitor C2 may be configured as parasitic capacitors, which are internal capacitors, but are not limited thereto, may be external capacitors intentionally designed on the outside of the driving element DT.

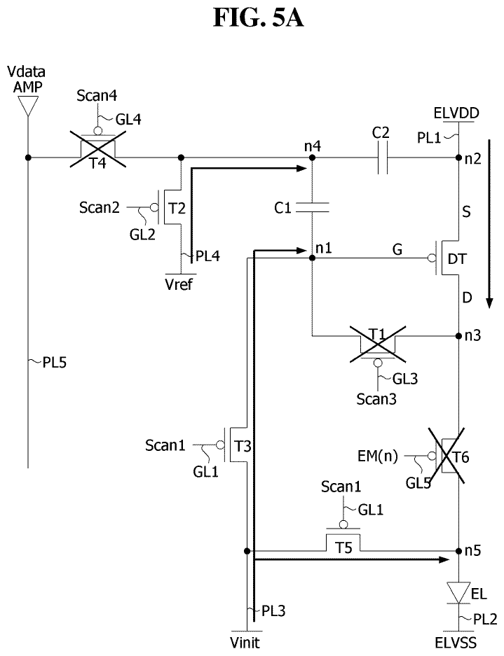

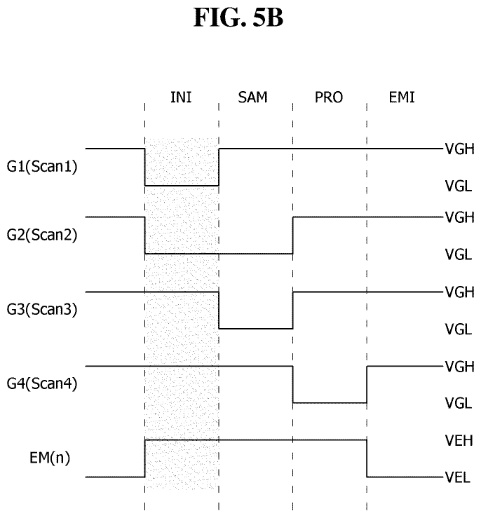

FIGS. 5A to 9B are diagrams illustrating operations of the pixel circuit according to one embodiment.

A refresh frame may include an initialization period INI, a sampling period SAM, a programming period PRO, and an emission period EMI. The initialization period INI is a period during which the capacitors and the gate electrode of the driving element DT are initialized, the sampling period SAM is a period during which the threshold voltage of the driving element DT is sensed, and the programming period PRO is a period during which the data voltage Vdata is stored, and the emission period EMI is a period during which the light-emitting element EL is turned on.

Referring to FIGS. 5A and 5B, in the initialization period INI, the first scan signal Scan1 and the second scan signal Scan2 output respectively from the first gate line GL1 and the second gate line GL2 may have a gate-on voltage VGL or VEL, and the scan signals output respectively from the third gate line GL3, the fourth gate line GL4, and the fifth gate line GL5 may have a gate-off voltage VGH or VEH. The driving element DT and the plurality of switch elements T1 to T6 according to the embodiment are p-channel transistors and thus may be turned off when a gate-high voltage is applied and turned on when a gate-low voltage is applied.

Specifically, the third switch element T3 may be turned on by the gate-on voltage VGL or VEL output from the first gate line GL1 to apply the initialization voltage Vinit to the first node n1. Accordingly, the initialization voltage Vinit may be applied to one end of the first capacitor C1 connected to the first node n1, and the gate electrode G of the driving element DT.

The initialization voltage Vinit may be a sufficiently low voltage to saturate the driving element DT. Thus, when the initialization voltage Vinit is applied to the gate electrode G of the driving element DT, the driving element DT may be turned on in advance before the sampling period, allowing a source-drain channel to be formed. Accordingly, the pixel driving voltage ELVDD may be applied to the third node n3. Thus, when sampling begins, the voltage applied to the third node n3 is quickly applied to the gate electrode of the driving element DT, allowing the threshold voltage to be quickly sampled.

In the initialization period INI, the fifth switch element T5 connected to the first gate line GL1 is turned on so that the initialization voltage Vinit may be applied to the fifth node n5. The initialization voltage Vinit may be set to a sufficiently low voltage so that the light-emitting element EL does not emit light during the initialization period INI.

As an example, when the pixel driving voltage ELVDD is set to 4.6 V and the cathode voltage ELVSS is set to −6.0 V, the initialization voltage Vinit may be set to −3.5 V to sufficiently saturate the driving element DT during initialization. However, this is an exemplary, and may be appropriately adjusted according to the characteristics of each element and the pixel circuit.

According to the embodiment, when the initialization voltage Vinit is applied to the first node n1, the initialization voltage Vinit is not short-circuited with the pixel driving voltage ELVDD applied to the second electrode D of the driving element DT. Thus, the gate-source voltage Vgs of the driving element becomes exactly Vinit-ELVDD, so that an on-bias voltage becomes large, which can improve an on-bias stress (OBS) effect. An OBS is an abbreviation for “on-bias stress,” referring to the operation of applying stress to a transistor to prevent or reduce fluctuations in a threshold voltage of the transistor.

Due to a time necessary for the hysteresis characteristics of the driving element DT to change when there is a significant change in grayscale values of pixel data, a response time may increase during a first frame period when an input image begins to be reproduced. As a result, a first frame response (FFR) may deteriorate. However, according to the embodiment, the hysteresis of the driving element DT is mitigated by a high OBS voltage in the initialization period INI, which may improve the FFR.

Since the gate-on voltage is applied to the second gate line GL2, the second switch element T2 may be driven and the reference voltage Vref may be applied to the fourth node n4. Thus, the first capacitor C1 may be initialized to Vinit-Vref, and the second capacitor C2 may be initialized to Vref-ELVDD.

In the emission period EMI, the driving element DT is required to be in the saturation state to apply a current to the light-emitting element EL. In order for the driving element DT to be saturated, a source-gate voltage Vsg is required to be greater than the threshold voltage Vth. For example, the reference voltage Vref is required to be greater than the data voltage Vdata (see Equation 1 below). When a negative polarity voltage is used as the reference voltage Vref along with the initialization voltage Vinit, the driving element DT may not become saturated.

The reference voltage Vref may be set to a predetermined voltage level to perform the role of fixing the fourth node n4 from being affected by the previous data voltage in the initialization period, and the role of maintaining the voltage of the fourth node n4 constant despite changes in a gate voltage of the driving element DT due to diode connections in the sampling period. The initialization voltage Vinit may be set low so that the driving element is sufficiently saturated during initialization. Accordingly, the reference voltage Vref and the initialization voltage Vinit have different roles and thus may have different voltage levels.

As an example, the reference voltage Vref may be set to 2 V or more to enable the data voltage Vdata to range from 0 V (White) to 2 V (Black). However, the range of each voltage is not necessarily limited thereto and may be variously modified. The reference voltage Vref may be appropriately set within a range greater than the initialization voltage Vinit and the data voltage Vdata and less than the pixel driving voltage ELVDD.

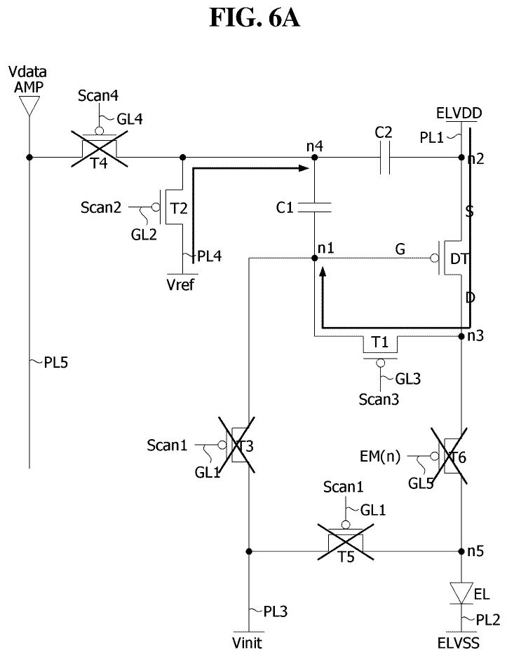

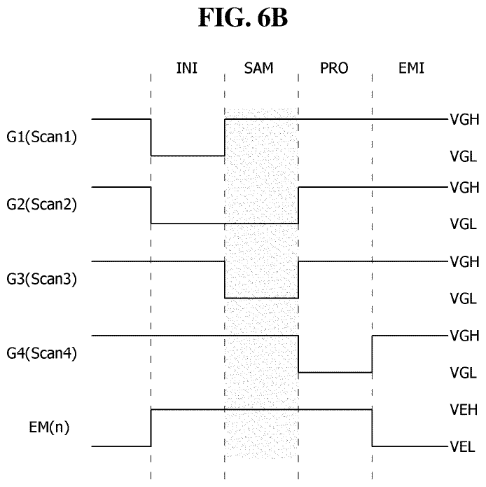

Referring to FIGS. 6A and 6B, in the sampling period SAM, the gate-off voltage VGH or VEH may be applied to the first gate line GL1, the fourth gate line GL4, and the fifth gate line GL5, and the gate-on voltage VGL or VEL may be applied to the second gate line GL2 and the third gate line GL3.

Accordingly, when the first switch element T1 is turned on by the gate-on voltage VGL or VEL applied to the third gate line GL3, the voltage charged in the third node n3 is charged to the first node n1.

Due to the gate-on voltage VGL or VEL applied to the second gate line GL2, the second switch element T2 may be turned on even in the sampling period to apply the reference voltage Vref to the fourth node n4. Accordingly, even when the voltage of the gate electrode of the driving element DT is changed from the initialization voltage Vinit to ELVDD-Vth during the transition from the initialization period INI to the sampling period SAM, the voltage of the fourth node n4 may remain constant.

In the sampling period SAM, ELVDD−|Vth| may be applied to the first node n1 connected to one end of the first capacitor C1, and the reference voltage Vref may be applied to the fourth node n4 connected to the other end of the first capacitor C1. Accordingly, the voltage charged to the first capacitor C1 may be the difference between ELVDD−Vth and Vref. For example, the voltage charged to the first capacitor C1 may be Vref−(ELVDD−Vth).

The reference voltage Vref may be applied to the fourth node n4 to which one end of the second capacitor C2 is connected, and the pixel driving voltage ELVDD may be applied to the other end of the second capacitor C2. The voltage charged to the second capacitor C2 may be the difference between ELVDD and Vref. For example, the voltage charged to the second capacitor C2 may be ELVDD-Vref. Thus, when the voltages stored in the first capacitor C1 and the second capacitor C2 are summed, the pixel driving voltage ELVDD and the reference voltage Vref may be canceled out, leaving only the threshold voltage Vth. In the sampling period SAM, the threshold voltage Vth of the driving element DT may be stored in the first capacitor C1.

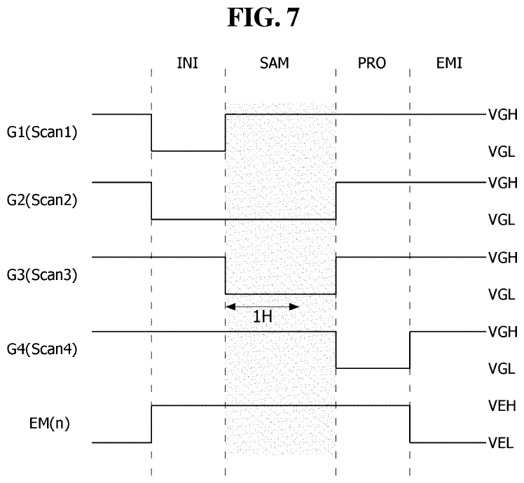

According to the embodiment, since sampling is performed using the reference voltage Vref rather than the data voltage Vdata, the sampling period SAM may be set to be longer or shorter than one horizontal period 1H. Thus, it is advantageous that, even during high-speed driving, the threshold voltage can be accurately sensed by ensuring sufficient sampling time without the limitation of one horizontal period. Referring to FIG. 7, the sampling time may be set to be longer than one horizontal period 1H by controlling the second scan signal Scan2 and the third scan signal Scan3.

In addition, since the threshold voltage is sensed using the pixel driving voltage ELVDD, the voltage of the gate electrode is quickly charged by the driving element DT that is already saturated in the initialization period INI, enabling a faster sampling time. Thus, fast sampling is possible, which can be advantageous for high-speed driving. In this case, the sampling time may be set to be shorter than one horizontal period.

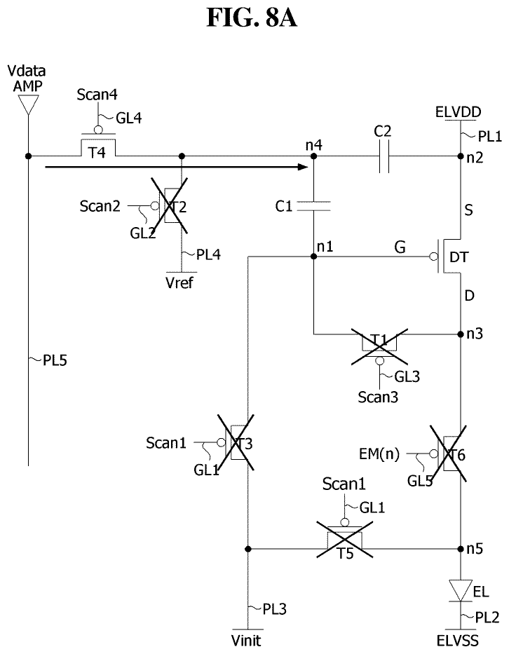

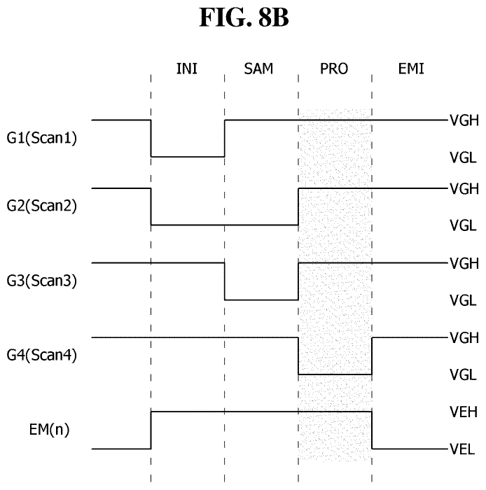

Referring to FIGS. 8A and 8B, in the programming period PRO, the gate-off voltage VGH or VEH may be applied to the first to third gate lines GL1 to GL3 and the fifth gate line GL5, and the gate-on voltage VGL or VEL may be applied to the fourth gate line GLA. Accordingly, only the fourth switch element T4 to which the fourth scan signal Scan4 is applied is turned on to apply the data voltage Vdata to the fourth node n4.

At this time, the first switch element T1 is turned off, and thus, the first node n1 is floated, so that the voltage of the first node n1 may become Vdata−Vref+ELVDD−Vth due to capacitor coupling.

The first capacitor C1 may be charged with a voltage corresponding to the difference between Vdata−Vref+ELVDD−Vth and Vdata. For example, the voltage charged to the first capacitor C1 may be Vdata−(Vdata−Vref+ELVDD−Vth).

The second capacitor C2 may be charged with a voltage corresponding to the difference between Vdata and ELVDD. For example, the voltage charged to the second capacitor C2 may be ELVDD−Vdata. Accordingly, when the voltages stored in the first capacitor C1 and the second capacitor C2 are summed, the pixel driving voltage ELVDD may be canceled out, leaving Vref−Vdata+Vth. The data voltage Vdata may be charged in the second capacitor C2 during the programming period PRO. The voltage stored in the first capacitor C1 and the second capacitor C2 may be the source-gate voltage Vsg.

At this time, the first capacitor C1 and the second capacitor C2 are connected in parallel, so that the data voltage Vdata is not distributed. Accordingly, the data voltage Vdata may be applied to both ends of each of the first capacitor C1 and the second capacitor C2. When the first capacitor C1 and the second capacitor C2 are connected in series and the data voltage is distributed, a wider data voltage range is required to be used, and the ratio of the distributed voltages may be influenced by the sizes of the capacitors, which can be difficult to control accurately.

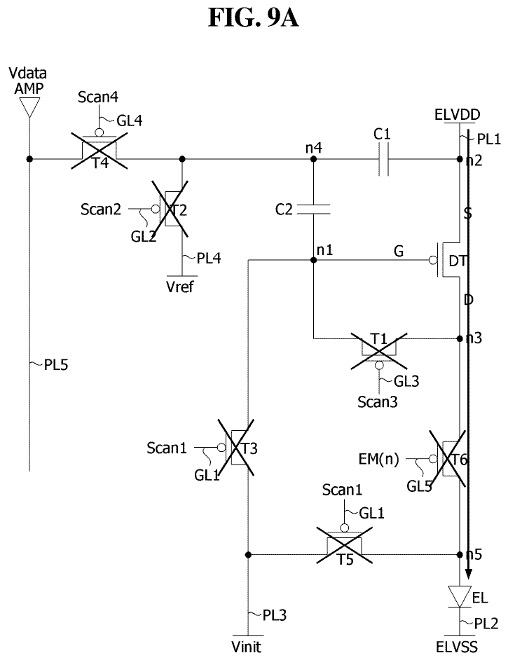

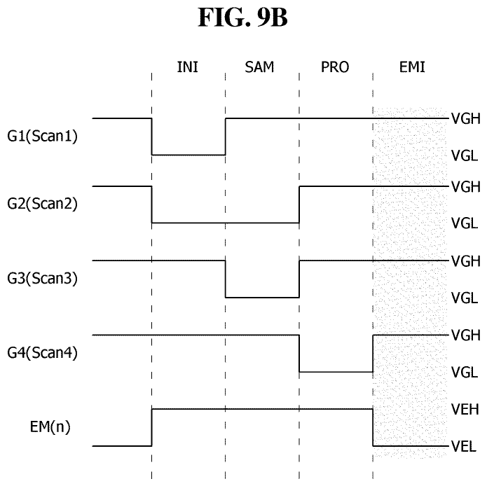

Referring to FIGS. 9A and 9B, in the emission period EMI, the gate-off voltage VGH or VEH may be applied to all of the first to fourth gate lines GL1 to GL4, the gate-on voltage VGL or VEL may be applied only to the fifth gate line GL5. Accordingly, the remaining switch elements except for the sixth switch element T6 may be turned off.

At this time, a current IOLED flowing to the light-emitting element EL, the source-gate voltage Vsg of the driving element, and the threshold voltage Vth of the driving element may satisfy Equation 1 below.

$$IOLED = k ( Vsg - \vert Vth \vert ) 2 = k \{ ELVDD - ( Vdata - Vref + ELVDD - \vert Vth \vert ) - \vert Vth \vert \} 2 = k ( Vref - Vdata ) 2 \qquad [ Equation 1 ]$$

Accordingly, the current flowing to the light-emitting element EL is determined by the difference between the reference voltage Vref and the data voltage Vdata, and does not affect the threshold voltage of the driving element DT, so that the driving element DT of each pixel can have uniform characteristics. Further, the influence on the pixel driving voltage ELVDD may be eliminated, which can also reduce the influence on IR drop.

Additionally, even when the pixel driving voltage ELVDD varies during the emission period EMI, the gate voltage of the driving element DT may change by α. Thus, as the pixel driving voltage ELVDD varies by α, the gate voltage of the driving element DT may also vary by α.

Substituting this into Equation 1 above, it can be seen that Equation 1 becomes k{(ELVDD+α)−(Vdata−Vref+ELVDD−|Vth|+α)−|Vth|}2, thereby confirming that the equation k(Vref−Vdata)2. Thus, luminance changes caused by a current-resistance (IR) drop (voltage drop) of the pixel driving voltage ELVDD can be prevented or reduced.

It is to be noted that although FIGS. 4 to 9B show the specific structure of the pixel circuit and the detailed operation thereof, the present disclosure is not limited thereto. For example, more or less transistors or capacitors may be included in the pixel circuit of the present disclosure, and the gate signals may be variously changed by those skilled in the art when necessary.

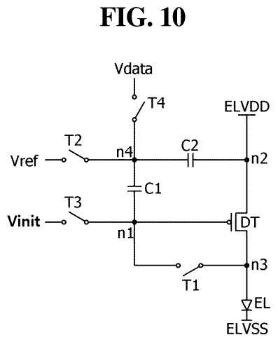

FIG. 10 is a diagram schematically illustrating the pixel circuit according to an embodiment of the present disclosure.

Referring to FIG. 10, the pixel circuit according to the example embodiment may include the light-emitting element EL, the driving element DT configured to drive the light-emitting element EL, a plurality of switch elements T1 to T4, and the capacitors C1 and C2.

In the initialization period, the second switch element T2 and the third switch element T3 are turned on so that the reference voltage Vref and the initialization voltage Vinit are applied to both ends of the first capacitor C1, respectively. At this time, the initialization voltage Vinit may be applied to the gate electrode of the driving element DT to saturate the driving element DT.

Thereafter, in the sampling period, the reference voltage Vref is applied to the fourth node n4, and the first switch element T1 is turned on, so that the voltage of the first node n1 becomes ELVDD-Vth. Accordingly, the threshold voltage Vth of the driving element DT may be stored in the first capacitor C1.

Thereafter, in the programming period, when the fourth switch element T4 is turned on and the data voltage Vdata is applied to the first node n1, the voltage of the fourth node n4 becomes Vdata−Vref+ELVDD−|Vth| due to capacitor coupling. At this time, the data voltage Vdata may be stored in the second capacitor C2.

Thus, in the emission period, a current may flow to the light-emitting element EL in proportion to Vref−Vdata without being affected by the threshold voltage of the driving element.

According to the embodiment, the capacitors are initialized using different voltages, which are the reference voltage Vref and the initialization voltage Vinit. The initialization voltage Vinit is advantageously set low to quickly saturate the driving element and increase the OBS effect. The reference voltage Vref is required to be greater than the data voltage Vdata to satisfy the condition for the driving element to be saturated. For example, in order for the driving element to be saturated, the source-gate voltage Vsg is required to be greater than the threshold voltage Vth, so that the reference voltage Vref is required to be greater than the data voltage Vdata according to Equation 1.

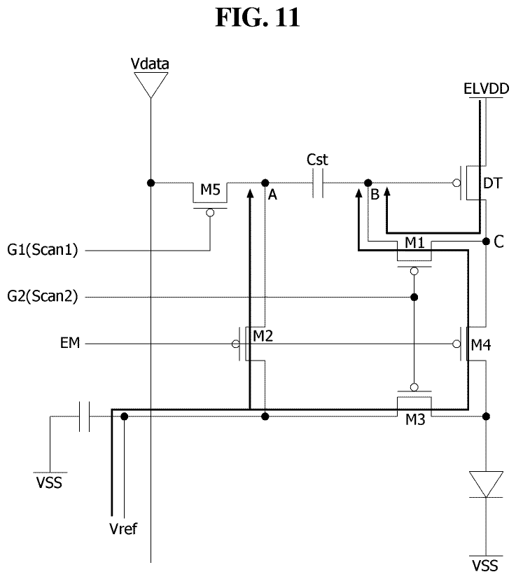

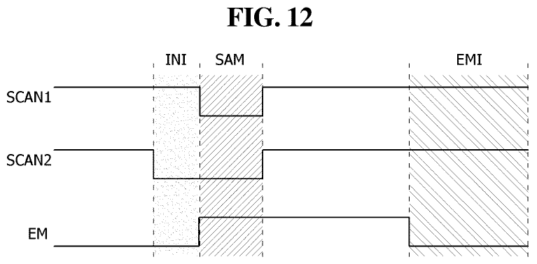

FIG. 11 is a diagram illustrating an example of a pixel circuit that performs sampling using a data voltage according to an embodiment. FIG. 12 is a waveform diagram of the circuit of FIG. 11 according to an embodiment.

Referring to FIGS. 11 and 12, in a 6T1C (6 thin-film transistors, 1 capacitor) pixel circuit, a first transistor M1, a second transistor M2, a third transistor M3, and a fourth transistor M4 may be turned on by applying the gate-on voltage VGL or VEL thereto, in an initialization period INI.

The reference voltage Vref may be applied to each of a node A and a node B, which are both ends of a capacitor Cst. Accordingly, the capacitor Cst may be initialized by applying the same reference voltage Vref to both ends thereof. At this time, the reference voltage Vref may be applied to the node B through the third transistor M3, the fourth transistor M4, and the first transistor M1.

When the reference voltage Vref is a sufficiently low initialization voltage, the driving element DT may be saturated and a source-drain channel may be open. Accordingly, there is a problem in which the reference voltage Vref and the pixel driving voltage ELVDD are short-circuited at a node C, causing continuous damage to the pixel circuit. However, according to the embodiment, the initialization voltage does not pass through the node to which a drain electrode of the driving element is connected, so that short-circuit between the initialization voltage and the pixel driving voltage can be prevented or reduced.

Further, in the 6T1C pixel circuit, a fifth transistor M5 is turned on and the data voltage Vdata is applied to the node A, in a sampling period SAM. In addition, the first transistor M1 may be turned on and the voltage at the node B may become ELVDD-Vth.

At this time, since the input of the data voltage Vdata and the sampling are driven simultaneously, the sampling period SAM is restricted to one horizontal period 1H during which the data voltage Vdata is applied. Accordingly, during high-speed driving, one horizontal period becomes shorter, making it impossible to secure sufficient sampling time. As a result, it is difficult to accurately sense the threshold voltage.

However, according to the embodiment, since sampling is performed using the reference voltage Vref rather than the data voltage Vdata, there is an advantage in that sufficient sampling time may be secured without being restricted to one horizontal period.

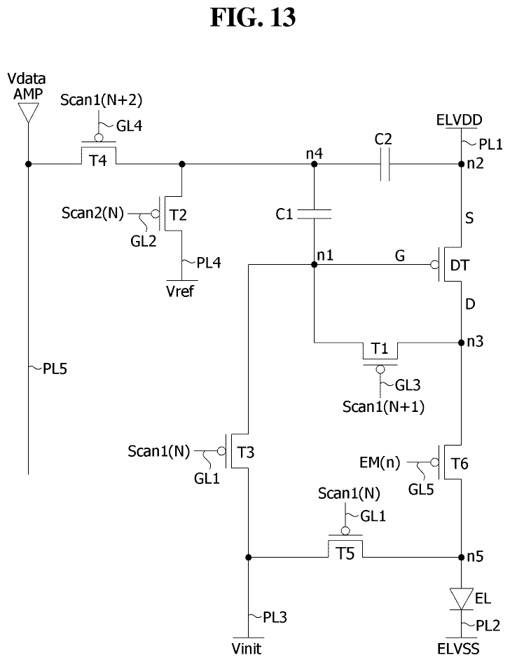

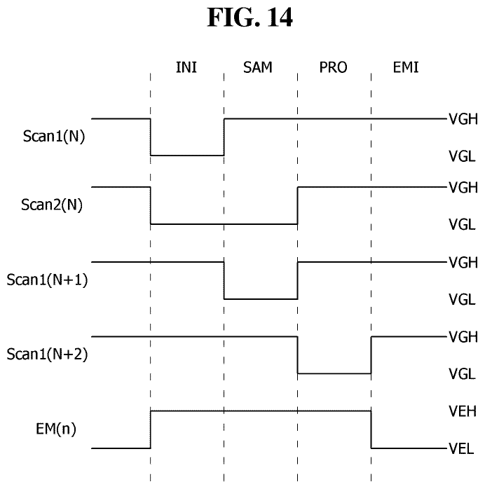

FIG. 13 is a diagram illustrating a pixel circuit according to another embodiment of the present disclosure FIG. 14 is a waveform diagram of the pixel circuit according to an embodiment of the present disclosure.

The pixel circuit according to the embodiment includes a light-emitting element EL, a driving element DT configured to drive the light-emitting element EL, a plurality of switch elements, and capacitors. The driving element DT and the switching elements may be implemented as transistors. The driving element DT and the switch elements may all be p-channel transistors, but the present disclosure is not necessarily limited thereto.

The driving element DT generates a current for driving the light-emitting element EL according to a gate-source voltage. The driving element DT includes a gate electrode connected to a first node n1, a first electrode connected to a second node n2, and a second electrode connected to a third node n3. A pixel driving voltage ELVDD is applied to the second node n2.

According to the embodiment, a first scan signal Scan1(N+1) of an (N+1)th line may be applied to a third gate line GL3, and a first scan signal Scan1(N+2) of an (N+2)th line may be applied to a fourth gate line GL4. With this configuration, the number of sub-stages that output a scan signal to one pixel may be reduced, thereby reducing the size of a gate driver.

In this case, when a width of the first scan signal Scan1(N+1) of the (N+1)th line is changed to ensure sufficient sampling time on an Nth line, an initialization period INI of an (N+1)th pixel can also be changed to the same period. For example, an initial time and the sampling time may be equally adjusted to be longer or shorter than one horizontal period.

A first switch element T1 may have a first electrode connected to the first node n1 and a second electrode connected to the third node n3. A gate electrode of the first switch element T1 may be connected to the third gate line GL3 through which the first scan signal Scan1(N+1) of the (N+1)th line is applied. One side of the first switch element T1 may be connected to the gate electrode of the driving element DT, and the other side of the first switch element T1 may be connected to the second electrode of the driving element DT and a sixth switch element T6.

The first switch element T1 may be turned on or turned off in response to the first scan signal Scan1(N+1) of the (N+1)th line, which is applied through the third gate line GL3, and may connect the first node n1 to the third node n3 when turned on.

A second switch element T2 may have a first electrode connected to a fourth node n4 and a second electrode connected to a reference voltage supply line PLA. A gate electrode of the second switch element T2 is connected to a second gate line GL2 through which a second scan signal Scan2(N) is provided.

The second switch element T2 may be turned on or turned off in response to the second scan signal Scan2(N), which is supplied through the second gate line GL2, and may supply a reference voltage Vref to the fourth node n4 when turned on.

A third switch element T3 may have a first electrode connected to the first node n1 and a second electrode connected to an initialization voltage supply line PL3. A gate electrode of the third switch element T3 is connected to a first gate line GL1 through which a first scan signal Scan1(N) is provided.

The third switch element T3 may be turned on or turned off in response to the first scan signal Scan1(N), which is supplied through the first gate line GL1, and may supply an initialization voltage Vinit to the first node n1 when turned on.

A fourth switch element T4 may have a first electrode connected to a data voltage supply line PL5 and a second electrode connected to the fourth node n4. A gate electrode of the fourth switch element T4 is connected to the fourth gate line GL4 through which the first scan signal Scan1(N+2) of the (N+2)th line is provided.

The fourth switch element T4 may be turned on or turned off in response to the first scan signal Scan1(N+2) of the (N+2)th line, which is supplied through the fourth gate line GL4, and may supply a data voltage Vdata to the fourth node n4 when turned on.

A fifth switch element T5 may have a first electrode connected to the initialization voltage supply line PL3 and a second electrode connected to a fifth node n5. A gate electrode of the fifth switch element T5 is connected to the first gate line GL1 through which the first scan signal Scan1(N) is provided.

The fifth switch element T5 may be turned on or turned off in response to the first scan signal Scan1(N), which is supplied through the first gate line GL1, and may supply the initialization voltage Vinit to an anode of the light-emitting element EL when turned on.

The sixth switch element T6 may have a first electrode connected to the third node n3 and a second electrode connected to the fifth node n5. A gate electrode of the sixth switch element T6 is connected to a fifth gate line GL5. The sixth switch element T6 may be turned on or turned off in response to a signal EM(n), which is applied through the fifth gate line GL5, and may connect the third node n3 to the fifth node n5 when turned on.

A first capacitor C1 and a second capacitor C2 may maintain a gate-source voltage Vgs of the driving element DT constant for one frame. The first capacitor C1 may store a threshold voltage Vth of the driving element DT, and the second capacitor C2 may store the data voltage Vdata.

A first terminal of the first capacitor C1 may be connected to the first node n1, and a second terminal thereof may be connected to the fourth node n4. The first terminal of the first capacitor C1 may be connected to the gate electrode of the driving element DT, the first electrode of the first switch element T1, and the first electrode of the third switch element T3.

A first terminal of the second capacitor C2 may be connected to the fourth node n4, and a second terminal thereof may be connected to the second node n2. The fourth node n4 may be disposed between the first capacitor C1 and the second capacitor C2 and connected to the second switch element T2 and the fourth switch element T4. The other side of the second capacitor C2 may be connected to a driving voltage supply line PL1.

Since the content of the present disclosure described in the problems to be solved, the problem-solving means, and effects does not specify essential features of the claims, the scope of the claims is not limited to matters described in the content of the disclosure.

According to an embodiment, a sampling time longer than one horizontal period can be secured, so that accurate sampling is possible even during high-speed driving. Accordingly, there is an advantage of achieving uniform driving characteristics between pixels even during high-speed driving.

Further, by ensuring that a pixel driving voltage and an initialization voltage are not short-circuited during initialization, damage to a pixel circuit can be minimized or reduced and low power control can be achieved.

Effects of the present disclosure will not be limited to the above-mentioned effects and other unmentioned effects will be clearly understood by those skilled in the art from the following claims.

While the embodiments of the present disclosure have been described in detail above with reference to the accompanying drawings, the present disclosure is not necessarily limited to these embodiments, and various changes and modifications can be made without departing from the technical spirit of the present disclosure. Accordingly, the embodiments disclosed herein are to be considered descriptive and not restrictive of the technical spirit of the present disclosure, and the scope of the technical spirit of the present disclosure is not limited by these embodiments. Accordingly, the above-described embodiments should be understood to be exemplary and not limiting in any aspect. The scope of the present disclosure should be construed by the appended claims, and all technical spirits within the scopes of their equivalents should be construed as being included in the scope of the present disclosure.

What is claimed is:

1. A pixel circuit comprising:
a driving element including a gate electrode connected to a first node, a first electrode connected to a second node, and a second electrode connected to a third node;
a light-emitting element connected to the second electrode of the driving element;
a first capacitor connected to the first node and a fourth node;
a second capacitor connected to the fourth node and the second node;
a first switch element connected to the first node and the third node;
a second switch element connected to the fourth node and a reference voltage supply line; and
a third switch element connected to the first node and an initialization voltage supply line.

2. The pixel circuit of claim 1, wherein a reference voltage applied from the reference voltage supply line is greater than an initialization voltage applied from the initialization voltage supply line.

3. The pixel circuit of claim 2, wherein the first capacitor is initialized by applying the reference voltage and the initialization voltage to both ends of the first capacitor respectively.

4. The pixel circuit of claim 3, wherein the second capacitor is initialized by applying the reference voltage and a pixel driving voltage to both ends of the second capacitor respectively.

5. The pixel circuit of claim 1, comprising:
a fifth switch element configured to connect the initialization voltage supply line and an anode of the light-emitting element; and
a first gate line connected to gate electrodes of the third switch element and the fifth switch element.

6. The pixel circuit of claim 2, further comprising:
a fourth switch element connected to the fourth node and a data voltage supply line.

7. The pixel circuit of claim 6, comprising:
a first gate line that applies a first gate voltage to a gate electrode of the third switch element;
a second gate line that applies a second gate voltage to a gate electrode of the second switch element;
a third gate line that applies a third gate voltage to a gate electrode of the first switch element; and
a fourth gate line that applies a fourth gate voltage to a gate electrode of the fourth switch element.

8. The pixel circuit of claim 6, wherein the pixel circuit is driven in an initialization period, a sampling period, a programming period, and an emission period,
wherein during the initialization period, the second switch element, the third switch element, and the driving element are turned on, and the first switch element and the fourth switch element are turned off,
wherein during the sampling period, the first switch element and the second switch element are turned on such that a level of the fourth node is fixed at the reference voltage, and a level of the first node is changed from the initialization voltage to a difference between a pixel driving voltage and a threshold voltage of the driving element,
wherein during the programming period, the fourth switch element is turned on, and the first switch element to the third switch element are turned off, such that the level of the first node is changed to the difference between the pixel driving voltage and the threshold voltage of the driving element, and
wherein during the emission period, a current flowing through the driving element has no relevance to the pixel driving voltage or the threshold voltage of the driving element.

9. The pixel circuit of claim 6, wherein the reference voltage is greater than a data voltage applied from the data voltage supply line.

10. The pixel circuit of claim 6, wherein the driving element and the first switch element to the fourth switch element are all p-channel transistors.

11. The pixel circuit of claim 1, wherein the initialization voltage supply line is electrically isolated from the second electrode of the driving element.

12. A display device comprising:
a data driving circuit;
a gate driving circuit; and
a pixel circuit comprising:
a driving element including a gate electrode connected to a first node, a first electrode connected to a second node, and a second electrode connected to a third node;
a light-emitting element connected to the second electrode of the driving element;
a first capacitor connected to the first node and a fourth node;
a second capacitor connected to the fourth node and the second node;
a first switch element connected to the first node and the third node;
a second switch element connected to the fourth node and a reference voltage supply line; and
a third switch element connected to the first node and an initialization voltage supply line.

13. The display device of claim 12, wherein the pixel circuit is driven in an initialization period, a sampling period, a programming period, and an emission period,
in the initialization period, the first capacitor is initialized by applying a reference voltage from the reference voltage supply line and an initialization voltage from the initialization voltage supply line to both ends of the first capacitor, respectively,
in the sampling period, a threshold voltage of the driving element is sampled using the reference voltage and a pixel driving voltage,
in the programming period, a data voltage is applied to the pixel circuit and the data voltage is stored in a second capacitor.

14. The display device of claim 13, wherein the sampling period is longer or shorter than one horizontal period.

15. The display device of claim 13, wherein the initialization period and the sampling period are a same in time length.

16. The display device of claim 13, wherein the initialization period and the sampling period are equally adjusted.

17. The display device of claim 12, wherein the driving element is turned on in the initialization period.

18. The display device of claim 13, wherein, in the programming period, a voltage applied to the fourth node is not distributed by the first capacitor and the second capacitor.
